(19) United States
(12) Patent Application Publication
(10) Pub. No.: US 2012/0174807 A1
(43) Pub. Date: Jul. 12, 2012

(54) Adjustable Inking or Dampening Apparatus for a Variable Cutoff Press and Method

(75) Inventor: Lev Zlatin, Portsmouth, NH (US)

(73) Assignee: GOSS INTERNATIONAL AMERICAS, INC., Durham, NH (US)

(21) Appl. No.: 13/326,483

(22) Filed: Dec. 15, 2011

Related U.S. Application Data
(60) Provisional application No. 61/423,646, filed on Dec. 16, 2010.

(51) Int. Cl. B41L 23/02

(52) U.S. Cl. 101/148

(57) ABSTRACT

An adjustable dampening apparatus and an adjustable inking apparatus is provided. The adjustable dampening apparatus includes a rotatable base for supporting a dampening roller, a rotatable socket connected to the rotatable base for adjusting a position of the dampening roller, a first actuating device connected to the rotatable base for positioning the rotatable base in a predetermined position for a given cutoff and a second actuating device connected to the rotatable socket for positioning the rotatable socket between a first position and a second position. Adjustable inking apparatus and variable cutoff printing presses are also provided. A method for adjusting dampening apparatus and inking apparatus are also provided.

Priority is hereby claimed to U.S. Provisional Application No. 61/423,646 filed on Dec. 16, 2010, the entire disclosure of which is hereby incorporated by reference herein.

The present invention relates generally to printing press equipment and more particularly to inking units and dampening units.

### BACKGROUND

U.S. Pat. No. 5,152,220 purportedly discloses a wiping device having a trough and a wiping cylinder which is mounted in the mutually opposite side walls of the trough. The trough is itself mounted tiltably about a pivot axis lying at least approximately in that plane which passes through the axis of rotation of the wiping cylinder and which is parallel to the tangential plane of the wiping cylinder and plate cylinder passing through the point of contact between the two cylinders.

U.S. Pat. No. 5,142,977 purportedly discloses a device for moving rollers of a printing press in two independent directions. The movement in each direction is independent of the movement in the other direction.

U.S. Pat. No. 5,555,806 purportedly discloses a roller assembly including a roller for a damping unit or an inking unit in a rotary printing machine, which is supported relative to rollers via pressure mechanism with springs, for example, a pressure spring and a leaf spring, so that the weight of the roller is balanced by the leaf spring.

U.S. Pat. No. 7,270,057 purportedly discloses an adjustment system for positioning a rolling element such as a form roller or an impression cylinder relative to a first cylinder having a first diameter and relative to at least a second cylinder adapted to replace the first cylinder and having a second diameter different than the first diameter.

U.S. Pat. No. 7,370,578 purportedly discloses an inking or damping unit that includes an applicator roll mounted on levers so that the application roll can be pivoted about a distributor cylinder onto a form cylinder with a controlled throw-on force.

### BRIEF SUMMARY OF THE INVENTION

When force is used as the primary criteria for setting the stripe between the inking roller and plate cylinder or the dampening roller and plate cylinder, known embodiments may provide inconsistent results. Resisting forces such as friction and weight of the rollers and cylinders are changing during printing and interfere with the force used to set or adjust the inking or dampening apparatus. The resisting forces cannot be accounted for in a way that provides consistent results.

An object of the present invention is to provide an inking or dampening apparatus design that keeps a center distance between a center of the plate cylinder and inking roller or dampening roller consistent for a given cutoff, yet permits movement of the inking roller and dampening roller as needed.

The present invention provides an adjustable dampening apparatus. The adjustable dampening apparatus provides a dampening solution to a plate cylinder. The adjustable dampening apparatus comprises a rotatable base for supporting a dampening roller, a rotatable socket connected to the rotatable base for adjusting a position of the dampening roller, a first actuating device connected to the rotatable base for positioning the rotatable base in a predetermined position for a given cutoff and a second actuating device connected to the rotatable socket for positioning the rotatable socket between a first position and a second position.

The present invention also provides an adjustable inking apparatus. The adjustable inking apparatus provides ink to a plate cylinder. The adjustable inking apparatus comprises a socket supporting an ink form roller, the socket having a slot for receiving a fastener, a first actuating device connected to a screw, the first actuating device positioning the socket in a predetermined position for a given cutoff by adjusting a position of the fastener along the screw and a second actuating device moving the socket between a first position and a second position to adjust a position of the ink form roller.

The present invention further provides another adjustable inking apparatus. The adjustable inking apparatus provides ink to a plate cylinder, the adjustable inking apparatus comprises a rotatable socket supporting an ink form roller, a first actuating device connected to the rotatable socket, the first actuating device positioning the socket in a predetermined position for a given cutoff and a second actuating device connected to the rotatable socket at a pivot, the second actuating device positioning the rotatable socket between a first position and a second position.

The present invention also provides a method of adjusting the dampening apparatus comprising the steps of setting the predetermined position of the rotatable base for the given cutoff length using the first actuating device, moving the rotatable socket between the first position and the second position and delimiting the rotation caused by the second actuating device.

The present invention also provides methods of adjusting the inking apparatus which includes the steps of setting the rotatable socket into a predetermined position for the given cutoff length using the first actuating device, moving the rotatable socket between the first position and second position using the second actuating device and delimiting the rotation caused by the second actuating device.

Moreover, the present invention provides a variable cutoff printing press. The press may include at least one printing unit having a plate cylinder and a blanket cylinder, the printing unit printing on a web, an adjustable dampening apparatus and an adjustable inking apparatus providing ink to the plate cylinder.

### BRIEF DESCRIPTION OF THE DRAWINGS

A preferred embodiment of the present invention will be elucidated with reference to the drawings, in which:

FIG. 1 shows a printing press including an adjustable dampening apparatus and an adjustable inking apparatus in accordance with the present invention;

FIGS. 2 to 6 show the adjustable dampening apparatus in accordance with the present invention; and

FIGS. 7 to 10 show two adjustable inking apparatus embodiments in accordance with the present invention.

### DETAILED DESCRIPTION OF PREFERRED EMBODIMENTS

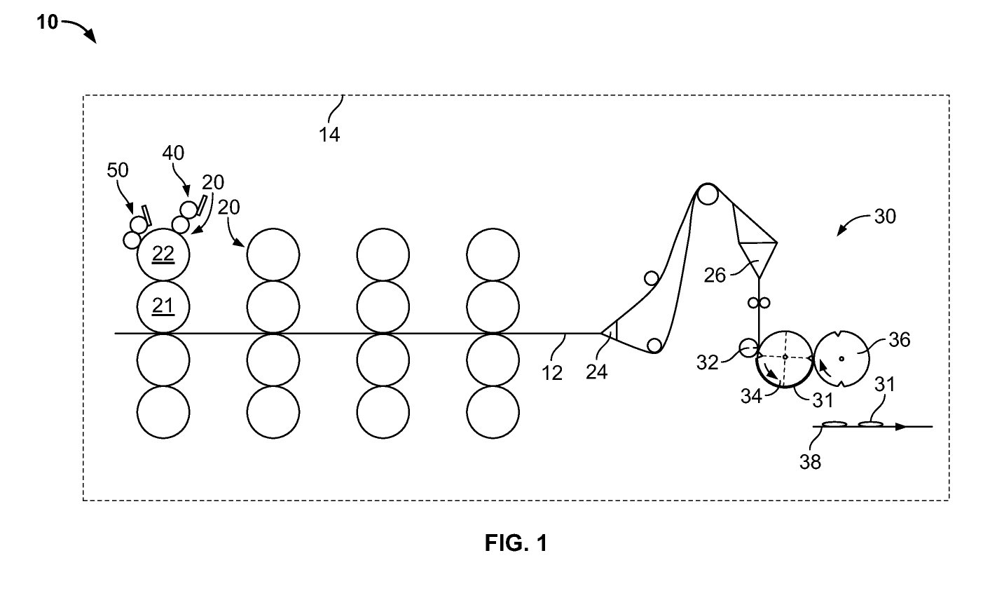

FIG. 1 shows a web offset, perfecting printing press including a dampening apparatus and inking apparatus in accordance with the present invention. Printing press 10 includes a plurality of printing units 20 printing on a web 12. Each printing unit may include a plate cylinder 22 and blanket cylinder 21. Printing press 10 is a variable cutoff printing press. Variable cutoff printing presses are able to a plurality of print jobs having a variety of cutoff lengths. In order to accommodate a variety of cutoff lengths, circumferences of plate and blanket cylinders may be varied, for example, blanket and plate cylinders of different sizes may be employed, existing cylinders may be packed or padded to increase their circumference, or printing plates and blankets having a variety of thicknesses may be interchanged.

Each plate cylinder 22 includes a corresponding dampening apparatus 40 and a corresponding inking apparatus 50 for supplying a dampening solution and ink to plate cylinder 22.

After a web 12 is printed, web 12 may be split into a plurality of ribbons by a splitter 24 then folded in half longitudinally by a former 26. A folder 30 of press 10 may include a knife cylinder 32 for cutting web 12 into signatures 31, a collect cylinder 34 for gripping and collecting signatures 31 and a jaw cylinder 36 for folding a plurality of collected signatures 31 in half. A conveyor 38 may be provided to transport signatures 31 further downstream for further processing and/or delivery.

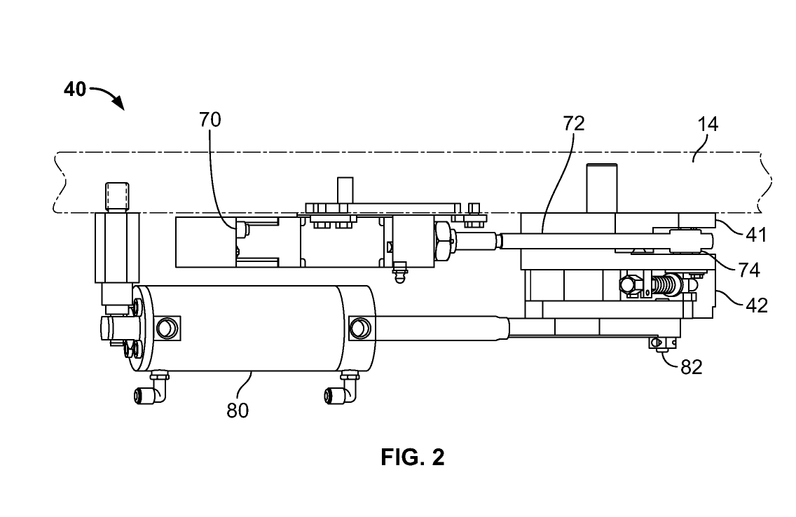

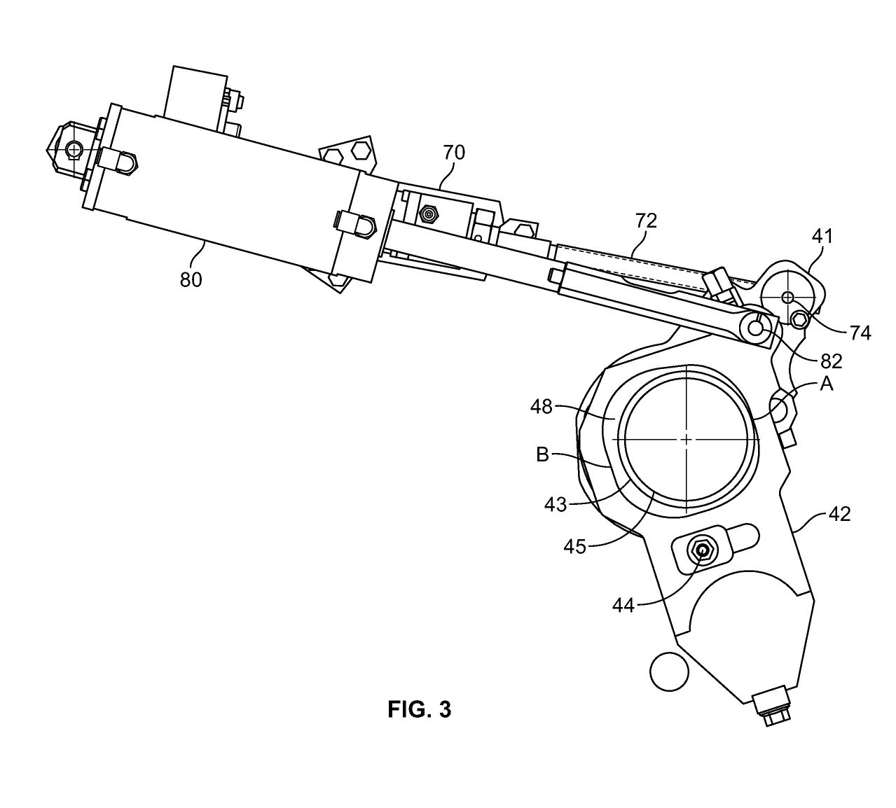

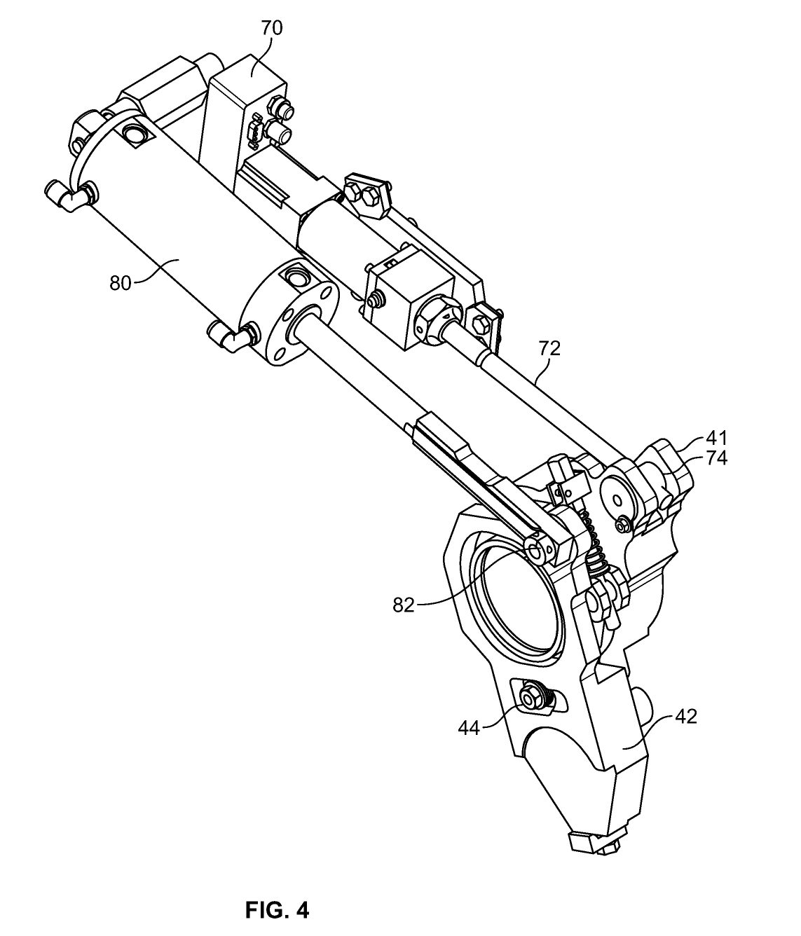

FIGS. 2 to 6 show a preferred embodiment of dampening apparatus 40 in accordance with the present invention including a rotatable base 41 attached to printing press frame 14. Base 41 is rotatable around vibrator roll bushing 45. A rotatable socket 42 is connected to rotatable base 41. Socket 42 is rotatable about a pivot 44. Vibrator bushing 45 extends into an opening 43 in socket 42.

Dampening apparatus 20 also includes two actuating devices 70, 80. A first actuating device 70 is connected to rotatable base 41. First actuating device 70 may include, for example, a smart motor, or a hydraulic cylinder. As shown in FIGS. 2 to 6, actuating device 70 includes a smart motor. Actuating device 70 is connected to rotatable base 41 by a screw 72 and nut 74. Actuating device 70 rotates base 41 about vibrator roll bushing 45 into a predetermined position for a given cutoff

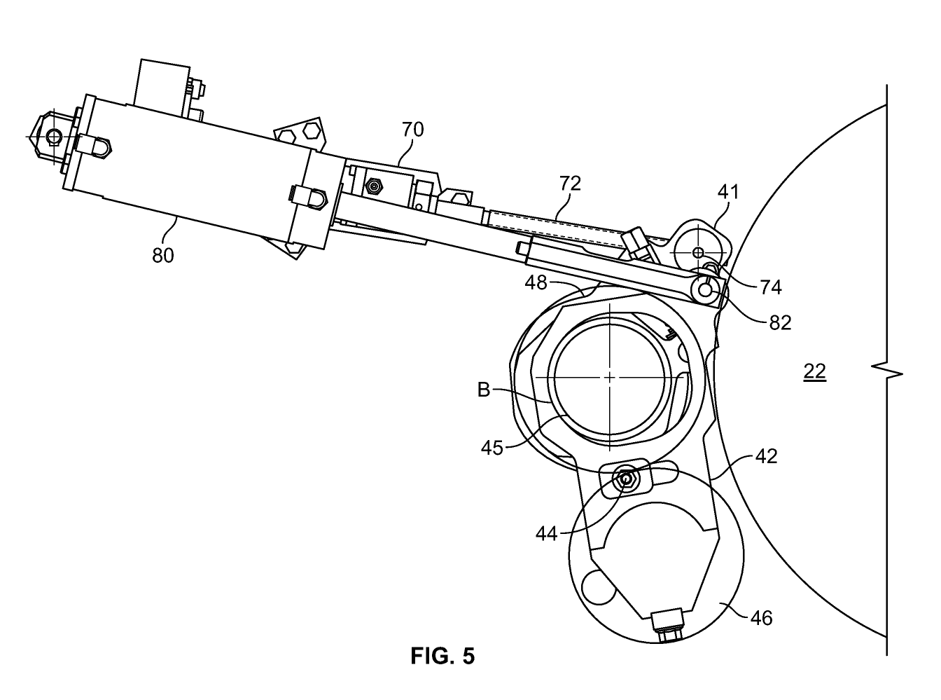

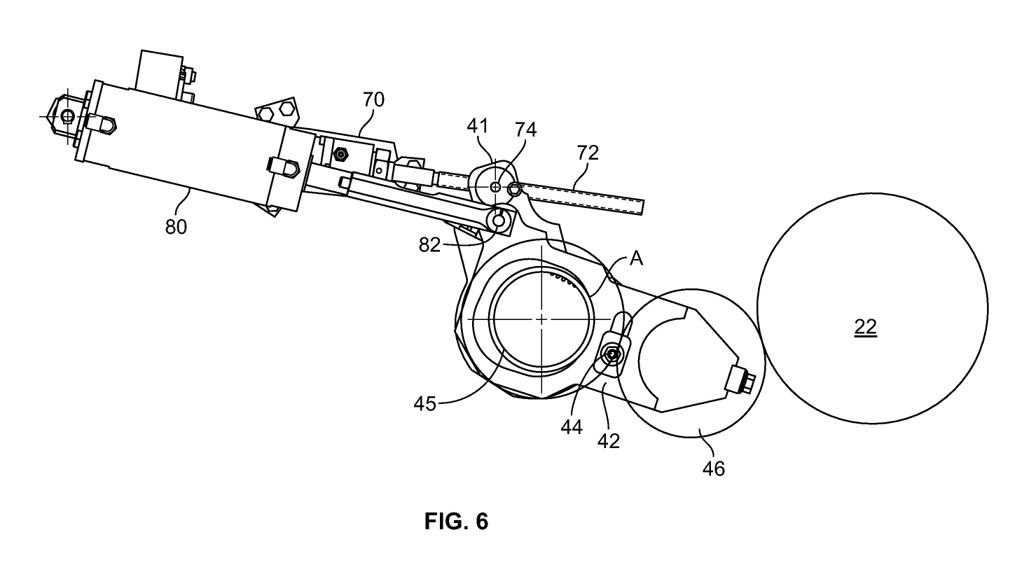

Dampening apparatus 40 also includes a second actuating device 80 connected to socket 42. Second actuating device 80 may be, for example, an air cylinder. Air cylinder 80 is secured to socket 42 by a nut 82. Actuating device 80 rotates socket 42 about pivot 44. However, since vibrator roll bushing 45 extends into an opening 43 in socket 42, vibrator bushing 45 limits an amount of rotation socket 42 can rotate about pivot 44. Thus, socket 42 moves between an “on position” in which a face A of opening 43 contacts vibrator roll bushing 45 and an “off position” in which a face B of opening 43 contacts vibrator roll bushing 45. In the “on position” dampening roller 46 contacts plate cylinder 22 as shown in FIG. 6. In the “off position” dampening roller 46 is spaced apart from plate cylinder 22 and vibrator roll 48 as shown in FIG. 5.

Thus, dampening apparatus 40 includes two actuating devices 70, 80 which provide respective adjustments. The first actuating device 70 adjusts a position of base 41 with respect to a given cutoff being printed on web 12. The position of base 41 remains unchanged for the duration of printing for this given cutoff. When the printing cutoff is changed, the position of base 41 is adjusted. The second actuating device 80 adjusts a position of socket 42 to move dampening roller 46 into and out of contact with plate cylinder 22 and vibrator roller 48 as desired. The two-part adjustability of dampening apparatus 40 permits base 41 to remain stationary for a given cutoff while moving and adjusting dampening roller 46 as needed. The limited movement of dampening roller 46 defined by vibrator roll bushing 45 in opening 43 allows for controlled movement between the “on position” and “off position.”

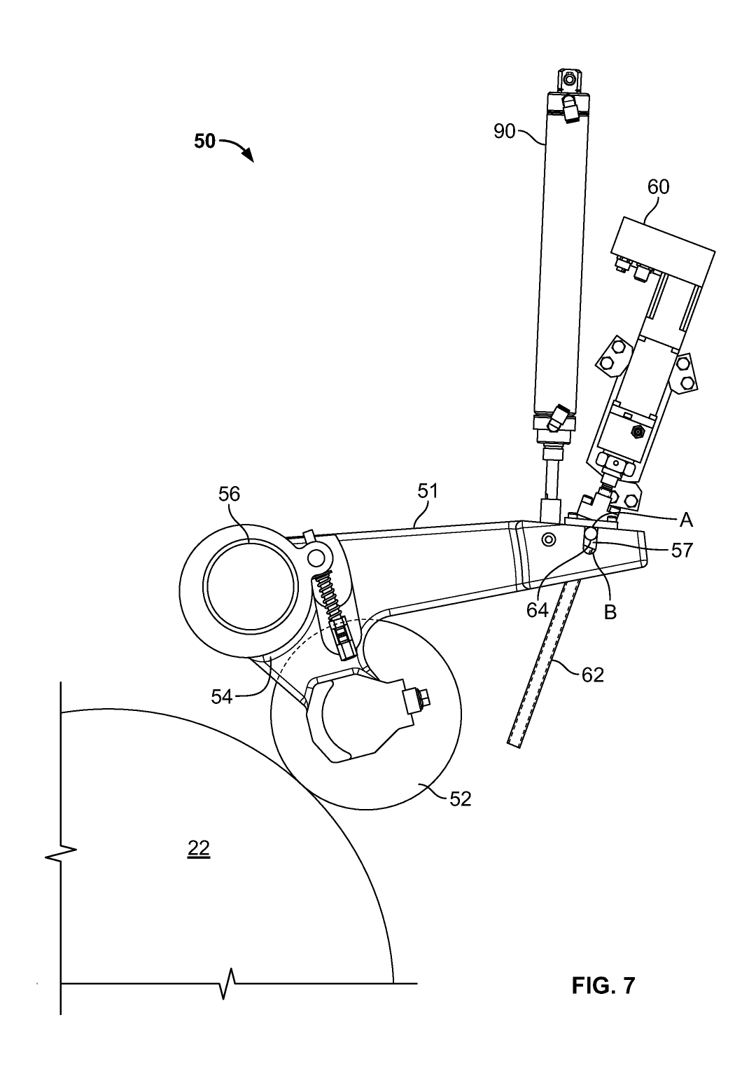

FIG. 7 shows an inking apparatus 50 in accordance with the present invention Inking apparatus 50 includes a socket 51, a first actuating device 60, a second actuating device 90, a fastener 64 and a screw 62. Socket 51 is rotatable about a vibrator bushing 56. First actuating device 60, which may be, for example, a smart motor, adjusts a position of fastener 64 along screw 62. Fastener 64 may be moved up and down along a length of screw 62 and is moved into position based on a corresponding cutoff. Fastener 64 extends into a slot 57 in socket 51 with socket 51 resting on fastener 64. Socket 51 rotates about bushing 56 following fastener 64 as fastener 64 is positioned, thereby positioning socket 51 for the corresponding cutoff.

Second actuating device 90 moves socket 51 between two positions, an “on position” in which fastener 54 is resting against a face A of slot 57 and an “off position” in which fastener 54 is resting against a face B of slot 57. In the “on position,” the form or inking roller 52 is thrown on plate cylinder 22 and in the “off position” the inking roller 52 is thrown off plate cylinder 22. The inking roller 52 does not need to be thrown off the vibrator roll 54 in either the on or off position. Second actuating device 90 may include, for example, an air cylinder. Slot 57 delimits movement of socket 51 caused by second actuating device 90.

Thus, inking apparatus 50 includes two actuating devices 60, 90 which provide respective adjustments. The first actuating device 60 adjusts a position of socket 51 with respect to a given cutoff. The position of socket 51 remains unchanged for a duration of printing for a given cutoff. When the printing cutoff is changed, the position of socket 51 is adjusted to accommodate the subsequent cutoff length. The second actuating device 90 adjusts a position of socket 51 to move inking roller 52 into and out of contact with plate cylinder 22 as desired. The two-part adjustability of inking apparatus 50 permits socket 51 to remain stationary for a given cutoff while moving the inking roller 52 as needed. The limited movement of inking roller 52 defined by fastener 64 in slot 57 allows for controlled movement between the two positions.

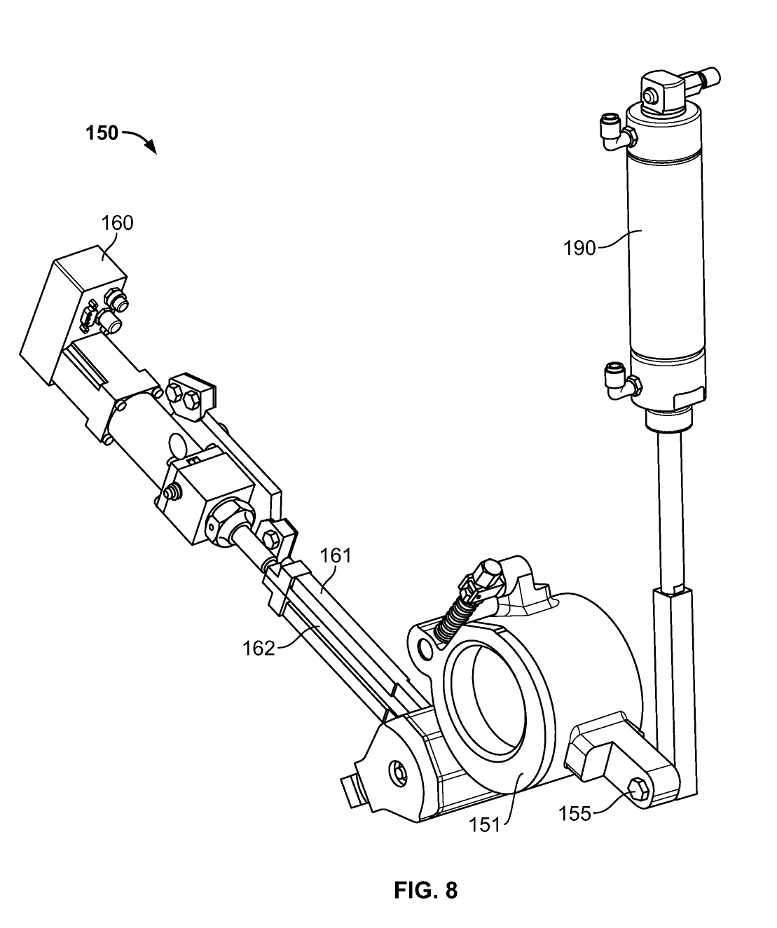

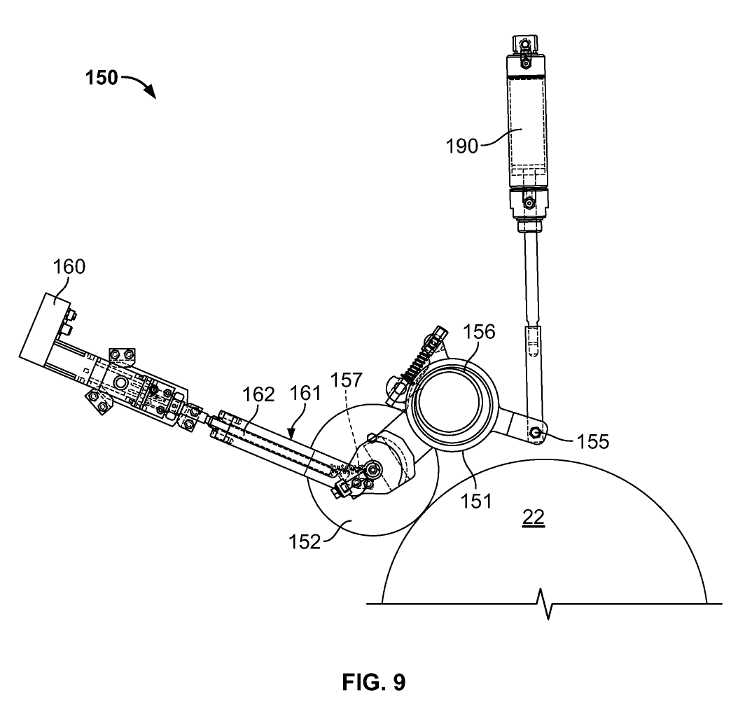

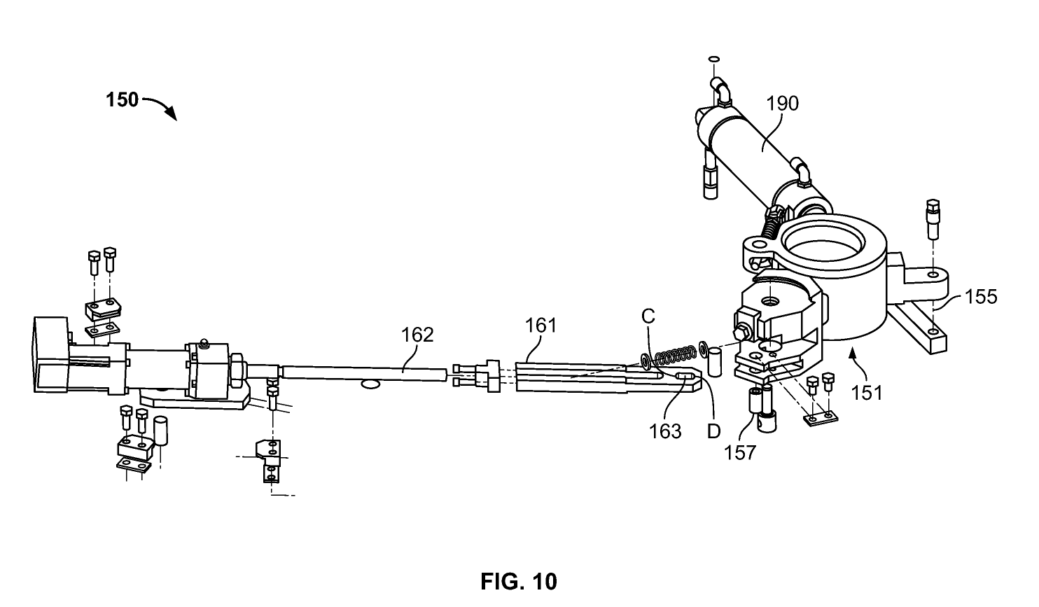

FIGS. 8 to 10 show another preferred embodiment of inking apparatus 150 in accordance with the present invention. Inking apparatus includes a long nut 161 which includes a slot 163 on one end. Long nut 161 receives a screw 162. Socket 151 includes a pin 157 fixed to the socket. Thus, in contrast to FIG. 6 in which the socket 51 includes a slot 57, in this embodiment, socket 151 includes a fixed pin 157.

Socket 151 is rotatable about bushing 156. A first actuating device 160 causes socket 151 to rotate about bushing 156 by extending or retracting screw 162 into or out of long nut 161 into position for a given cutoff. After this primary position is set for the given cutoff, a second actuating device 190 rotates socket 151 about a pivot 155 in order to throw an ink or form roller 152 on and off plate cylinder 22. Rotation of socket 151 is delimited by slot 163. Pin 157 will move between a position in which pin 157 rests against a face C of slot 163 or a face D of slot 163 to move the inking roller 152 in and out of contact with plate cylinder 22.

Inking apparatus 150 shown in FIGS. 8 to 10 also includes two actuating devices 160, 190 which provide respective adjustments. The limited movement of inking roller 152 is defined by pin 157 and slot 163 which allow for controlled movement between the two positions.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. An adjustable dampening apparatus providing a dampening solution to a plate cylinder, the adjustable dampening apparatus comprising:
a rotatable base for supporting a dampening roller;
a rotatable socket connected to the rotatable base for adjusting a position of the dampening roller;
a first actuating device connected to the rotatable base for positioning the rotatable base in a predetermined position for a given cutoff; and
a second actuating device connected to the rotatable socket for positioning the rotatable socket between a first position and a second position.

2. The adjustable dampening apparatus as recited in claim 1 wherein the second actuating device rotates the rotatable socket about a pivot.

3. The adjustable dampening apparatus as recited in claim 2 wherein a vibrator roll bushing for supporting a vibrator roll extends into an opening of the rotatable socket, the vibrator roll bushing limiting an amount of rotation of rotatable socket about the pivot.

4. The adjustable dampening apparatus as recited in claim 1 wherein the first actuating device is a smart motor.

5. The adjustable dampening apparatus as recited in claim 1 wherein the second actuating device is a hydraulic cylinder.

6. The adjustable dampening apparatus as recited in claim 1 wherein the first position is a throw-off position in which the dampening roller is spaced apart from the plate cylinder and the second position is a throw-on position in which the dampening roller is contacting the plate cylinder.

7. The adjustable dampening apparatus as recited in claim 6 wherein the dampening roller is spaced apart from the vibrator roll and the plate cylinder when the dampening roller is in the first position

8. A variable cutoff printing press comprising:
at least one printing unit having a plate cylinder and a blanket cylinder, the printing unit printing on a web; and
the adjustable dampening apparatus as recited in claim 1.

9. The variable cutoff printing press as recited in claim 8 further comprising:
an adjustable inking apparatus providing ink to the plate cylinder.

10. A method of adjusting the dampening apparatus as recited in claim 1, comprising the steps of:
setting the predetermined position of the rotatable base for the given cutoff length using the first actuating device;
moving the rotatable socket between the first position and the second position; and
delimiting the rotation caused by the second actuating device.

11. An adjustable inking apparatus providing ink to a plate cylinder, the adjustable inking apparatus comprising:
a socket supporting an ink form roller, the socket having a slot for receiving a fastener;
a first actuating device connected to a screw, the first actuating device positioning the socket in a predetermined position for a given cutoff by adjusting a position of the fastener along the screw; and
a second actuating device moving the socket between a first position and a second position to adjust a position of the ink form roller.

12. The adjustable inking apparatus as recited in claim 11 wherein the first actuating device is a smart motor.

13. The adjustable inking apparatus as recited in claim 11 wherein the second actuating device includes an air cylinder.

14. The adjustable inking apparatus as recited in claim 11 wherein the fastener contacts a first face of the slot in the first position and a second face of the slot in the second position.

15. The adjustable inking apparatus as recited in claim 11 wherein the first actuating device rotates the socket about a first pivot.

16. The adjustable inking apparatus as recited in claim 11 wherein the first pivot is a vibrator roll bushing.

17. A variable cutoff printing press comprising:
at least one printing unit having a plate cylinder and a blanket cylinder, the printing unit printing on a web; and
the adjustable inking apparatus as recited in claim 11.

18. An adjustable inking apparatus providing ink to a plate cylinder, the adjustable inking apparatus comprising:
a rotatable socket supporting an ink form roller;
a first actuating device connected to the rotatable socket, the first actuating device positioning the socket in a predetermined position for a given cutoff; and
a second actuating device connected to the rotatable socket at a pivot, the second actuating device positioning the rotatable socket between a first position and a second position.

19. The variable cutoff printing press as recited in claim 18 wherein the socket includes a pin.

20. The variable cutoff printing press as recited in claim 19 further comprising a long nut connected the rotatable socket.

21. The variable cutoff printing press as recited in claim 20 wherein the first actuating device is connected to a screw, first actuating device positions the socket in the predetermined position for a given cutoff by retracting or extending the screw into the long nut.

22. The variable cutoff printing press as recited in claim 21 wherein the socket rotates about a vibrator roll bushing.

23. The variable cutoff printing press as recited in claim 20 wherein the long nut includes a slot for receiving the pin, the slot and pin limiting movement of the socket about the pivot.

24. A variable cutoff printing press comprising:
at least one printing unit having a plate cylinder and a blanket cylinder, the printing unit printing on a web; and
the adjustable inking apparatus as recited in claim 18.

25. The variable cutoff printing press as recited in claim 9 wherein the adjustable inking apparatus includes:
an ink socket supporting an ink form roller, the ink socket having a slot for receiving a fastener;
a first ink actuating device connected to a screw, the first ink actuating device positioning the ink socket in a predetermined ink position for the given cutoff by adjusting a position of the fastener along the screw; and
a second ink actuating device moving the ink socket between a first ink position and a second ink position to adjust a position of the ink form roller.

26. The variable cutoff printing press as recited in claim 9 wherein the adjustable inking apparatus includes:
a rotatable ink socket supporting an ink form roller;
a first ink actuating device connected to the rotatable ink socket, the first ink actuating device positioning the socket in a predetermined ink position for the given cutoff; and
a second ink actuating device connected to the rotatable ink socket at a pivot, the second ink actuating device positioning the rotatable ink socket between a first ink position and a second ink position.
